(19) United States
(12) Patent Application Publication
(10) Pub. No.: US 2004/0244789 A1
(43) Pub. Date: Dec. 9, 2004

(54) Sawing wire

(76) Inventor: Christian Jentgens, Eschlikon (CH)

Correspondence Address: SHOEMAKER AND MATTARE, LTD, 10 POST OFFICE ROAD - SUITE 110, SILVER SPRING, MD, 20910, US

(21) Appl. No.: 10/494,341

(22) PCT Filed: Oct. 28, 2002
(86) PCT No.: PCT/EP02/12002

(30) Foreign Application Priority Data
Nov. 13, 2001 (EP) 01811090.8
Sep. 26, 2002 (EP) 02405834.9

(51) Int. Cl. B28D 1/08

(52) U.S. Cl. 125/16.02

(57) ABSTRACT

A sawing yarn comprises an abrasive mixture which contains a bonding resin and an abrasive material, as well as a multifilament core made of fibers which are resistant to breaking. The fibers are arranged substantially parallel to one another and are enveloped by the abrasive mixture. The bonding resin contains no polytetrafluoroethylene, and the quantity of abrasive material in the mixture gradually decreases from the surface of the abrasive yarn inward. The yarn is suitable for cutting hard and brittle materials such as single-crystal silicon.

### BACKGROUND OF THE INVENTION

The present invention relates to a sawing yarn, a process for its production and its use for cutting or dividing hard materials, such as, for example, monocrystalline silicon.

Thin disks of brittle hard materials are used in numerous industrial sectors. The use of so-called silicon wafers in semiconductor technology may be mentioned as only one prominent example. Such disks are as a rule obtained from blocks or single crystals of the corresponding materials by cutting or dividing processes. These cutting or dividing processes are conventionally carried out using a steel sawing wire in the presence of an abrasive. As a rule, the abrasive is applied to the sawing wire in the form of a loose slurry during the cutting process, in order to permit cutting of the material. Such an apparatus is described, by way of example, in U.S. Pat. No. 4,187,828. However, this conventional method suffers from the disadvantage that the sawing wire is severely worn during the operation and as a rule can be used only once. Moreover, a not inconsiderable quantity of nonrecyclable wastes result during the use of loose slurries of abrasive material.

Efforts have therefore been made to make the sawing wire more resistant by direct application of the abrasive to its surface. Thus, EP-A-0 982 094 describes a sawing wire where a steel sawing wire is bound via an adhesion-promoting intermediate layer to a metallic bonding phase into which the abrasive, for example diamond particles, is incorporated. A similar wire saw is also described in U.S. Pat. No. 4,485,757. Such sawing wires are, however, expensive in terms of the production process. Moreover, they often suffer from the problem of hydrogen embrittlement and spontaneous fractures resulting therefrom.

JP-A-207598 describes a sawing wire which consists of a piano wire and abrasive particles which are fastened to the surface of the wire by means of a certain binder. Owing to the addition of additives, such as metal particles, the binder is more resistant to external influences. U.S. Pat. No. 5,313,742 describes cutting wheels which have increased strength owing to their one-piece design with a greater thickness in the central, non-cutting region and a smaller thickness in the outer cutting regions. The cutting wheel consists of a bonding resin into which abrasive particles have been mixed.

The cutting tools described above meet the set requirements with respect to the use for cutting hard brittle materials, but not optimally. Particularly in the case of expensive materials, such as single silicon crystals, the cutting widths should be very small in order to minimize the cutting loss. Of course, the diameter of the cutting tool increases as a result of application of a layer containing the abrasive to the wire, with the result that the cutting width is increased. With the use of abrasive in the form of a loose slurry, it is necessary to employ high cutting speeds of about 1000 m/min in order to achieve entrainment of the abrasive particles and hence a cut. This leads to a considerable temperature increase and makes water cooling during the cutting process unavoidable. With the use of diamond as abrasive material, locally greatly increased temperatures occur owing to the very good thermal conductivity properties of this material, even in the case of water cooling, and hence a considerable load for the cutting tool and resulting faster wear. If the abrasive is fastened on the surface of the cutting tool, the cutting tool will become unusable after removal of this surface layer, something which occurs very rapidly owing to the above-described conditions during the cutting of hard brittle materials.

Composite materials comprising a core of fiber material and a polymer matrix filling this fiber material are in principle known. For example, U.S. Pat. No. 5,068,142 describes such a fiber-reinforced composite material for use in the building industry, for example for preventing landslides. This composite material consists of a plurality of fibers and has a total thickness in the region of several millimeters or more.

WO 93/18891 describes a brush for polishing surfaces, which consists of a thermoplastic polymer with abrasive particles present therein. However, this publication expressly points out that the structures described there differ, particularly with regard to the tensile strength, from structures in which a preshaped core material is subsequently covered with a coating of abrasive-filled thermoplastic elastomer. It is not stated that the filaments mentioned there can be used for cutting hard brittle materials.

JP-A-10-151559 describes a wire saw which is suitable for repeated cutting with water cooling. This saw consists of a multifilament yarn, on the surface of which and in the interior of which abrasive is provided. The abrasive is bound to the multifilament by means of a particular bonding resin based on polytetrafluoroethylene as an indispensable component. The abrasive/binder mixture is applied in the form of a dispersion to the multifilament. This necessitates a subsequent evaporation step, in which bubble formation occurs. An exact cylindrical shape of the sawing wire is therefore not obtainable. Moreover, the use of fluorine-containing binders is unacceptable for ecological and toxicological reasons.

The possibility of using plastics as material for sawing wires is described in principle in FR-A-1 142 604. In this publication, however, only a sawing wire having at most 3 plastics fibers is described. The use of a multifilament required for the sawing applications of the present invention is not disclosed.

### SUMMARY OF THE INVENTION

It was therefore the object of the present invention to provide a cutting tool by means of which the disadvantages of the prior art which are described above can be overcome.

The above object is achieved, according to the invention, by a sawing yarn comprising an abrasive mixture containing a bonding resin and abrasive material, and a multifilament of fibers which have high tensile strength and are preferably arranged substantially parallel to one another and surrounded by the abrasive mixture, the space between the fibers being filled with the abrasive mixture, characterized in that the bonding resin contains no polytetrafluoroethylene.

A further aspect of the present invention relates to a sawing yarn, comprising an abrasive mixture containing a bonding resin and abrasive material, and a multifilament of fibers which have high tensile strength and are preferably arranged substantially parallel to one another and surrounded by the abrasive mixture, the space between the fibers being filled with the abrasive mixture, characterized in that the amount of abrasive material in the abrasive mixture decreases gradually from the surface of the sawing yarn to the interior. In other words, more abrasive material particles are present at the surface than in the interior in the case of this sawing yarn. A gradual decrease of the amount of abrasive material is to be understood according to the present invention as meaning that the amount of abrasive material decreases substantially continuously from the surface of the yarn to its interior. Certain deviations of the continuity, for example deviations of about 10%, may arise from the production process. According to the invention, the amount of abrasive material in the sawing yarn preferably decreases from the surface to the interior by in each case 2-60%, preferably by 5-40%, particularly preferably by 5-20%, after a distance of 30 μm. In the case of this aspect of the present invention, too, the bonding resin preferably contains no polytetrafluoroethylene.

According to a preferred embodiment of the present invention, the sawing yarn has a thickness equal to or less than 350 μm.

According to a preferred embodiment of the present invention, the sawing yarn has a thickness of 125-300 μm.

According to the present invention, multifilament is understood as meaning a composite material that is composed of many individual fibers.

Surprisingly, it was found that the sawing yarns according to the invention are outstandingly suitable for cutting hard brittle materials. Through the use of comparatively few fibers, in the range of 200-1000 fibers, preferably 200-800 fibers, the composite material has a diameter of about 125 to 350 μm, with the result that cutting widths of less than or equal to 350 μm can be achieved. In contrast to the cutting tools of the prior art, in which an abrasive-containing layer is present only on the surface of a metal wire and which consequently become unusable after this surface is worn down, an abrasive mixture is present between the individual fibers in the sawing yarn according to the invention. On abrasion of the surface of the sawing yarn, fresh abrasive material in the interior of the abrasive yarn is thus exposed during the operation, which fresh abrasive material can replace the abrasive material which was originally present at the surface and was lost through wear. By means of the sawing yarn according to the invention, it is therefore possible to achieve substantially greater tool lives during the cutting of hard brittle materials.

Moreover, the cutting of hard brittle materials with the sawing yarns according to the invention can be carried out at lower cutting speeds. Consequently, the load of the cutting tool due to increased temperatures occurring during the cutting is reduced. In addition, a more careful procedure is possible, permitting more precise cuts with less cutting loss. Feeding of a loose slurry of abrasive material is not necessary.

Moreover, in contrast to the sawing yarn of JP-A-10 151 559, the sawing yarn according to the invention is not limited to a bonding resin which contains polytetrafluoroethylene as an indispensable component and therefore does not have the ecological and toxicological disadvantages associated therewith.

Furthermore, according to the present invention, a sawing yarn that has an exact cylindrical shape can be obtained. Thus, the sawing yarn according to the invention has substantially better cutting properties.

The sawing yarn according to the invention can be produced in a simple and economical manner, as described below.

### BRIEF DESCRIPTION OF THE DRAWINGS

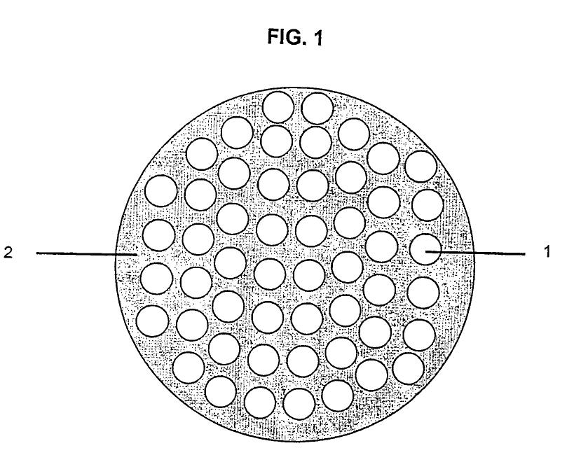

The present invention is explained below in more detail with reference to illustrative and non-restricting drawings. FIG. 1 shows a cross section through a sawing yarn according to the invention.

### DESCRIPTION OF THE PREFERRED EMBODIMENT(S)

As shown in FIG. 1, the sawing yarn according to the invention comprises a multifilament of fibers (1) which have high tensile strength and are arranged substantially parallel to one another embedded in an abrasive mixture (2) and are separated from one another by the abrasive mixture (2). The sawing yarn according to the invention comprises 200 to 1000, preferably 200 to 800, individual fibers (1). This results in a sawing yarn thickness equal to or less than 350 μm, preferably 125-300 μm. The fibers preferably have a substantially round cross section, other shapes also being possible according to the invention.

The fibers (1) may be produced from materials which are used for the production of fiber-reinforced materials. Fibers of m- and/or p-aramid (aromatic polyamide), ultra-high-strength polyethylene, highly oriented polyester, polyester, polyamide, carbon fibers or glass fibers and stranded wires may be mentioned by way of example. The use of fibers of m-aramid, which are sold by Du Pont under the trade name Nomex® and by Teijin under the trade name Teijinconex®, and/or p-aramid, which are sold by Du Pont under the trade name Kevlar®, by Twaron under the trade name Twaron® and by Teijin under the trade name Technora®, and/or of fibers of ultra-high-strength polyethylene, which are sold by Toyobo under the trade name Dyneema®, is preferred according to the invention. The use of fibers of p-polyphenylene-2,6-benzobisoxazole, which are sold by Toyobo under the trade name Zylon®, is particularly preferred according to the invention. According to the invention, however, combinations of all abovementioned materials can also be used as fiber material for the sawing yarns according to the invention.

The fibers (1) must have a tensile strength which meets the requirements of the process for cutting hard brittle materials. According to the present application, therefore, a fiber having a high tensile strength is to be understood as meaning a fiber which has a tensile strength of more than 25 cN/tex or more than 300 MPa. The abovementioned fiber materials meet this requirement.

Owing to the lower cutting speeds which are required when the sawing yarn according to the invention is used for cutting hard brittle materials, it is also possible to use, for the production of the sawing yarn, materials which would be unsuitable for conventional cutting tools, owing to the high temperatures occurring during their use.

As is evident from FIG. 1, the fibers (1) are embedded substantially parallel to one another in an abrasive mixture (2). The abrasive mixture (2) contains a bonding resin and abrasive material. According to the invention, the bonding resin may be a solid resin or a liquid resin. These may be known thermoplastic or thermosetting polymers or a combination of these materials, with the exception of the fluorine-containing binders which are particularly ecologically and toxicologically disadvantageous. Thermoplastics, such as polyimides, polybenzimidazoles, polycarbonates, polyethylene terephthalates, polybutylene terephthalates, polyamides, polyphenylene ethers, polyphenylene sulfides, polyaryl ether ketones, polyether ether ketones or thermosetting plastics, such as, for example, curable phenol resins, curable phenol/formaldehyde resins, polyimide resins, bismaleimides, epoxy resins, unsaturated polyester resins, DAP resins (polydiallyl phthalate), MF molding materials, such as, for example, melamine/fornaldehyde molding materials, curable melamine/phenol/formaldehyde (MPF) molding materials or crosslinked polyurethanes, may be mentioned by way of example. Here, preferred materials among the thermoplastics are polyethylene terephthalates, polybutylene terephthalates, polycarbonates or polyamides, while curable phenol resins, epoxy resins, curable phenol/formaldehyde resins, MF molding materials, such as, for example, melamine/formaldehyde molding materials, and curable melamine/phenol/formaldehyde (MPF) molding materials are particularly preferred among the thermosetting plastics. According to the invention, thermosetting plastic materials are particularly preferred. According to the present invention, mixtures of the above substances may also be used as bonding resin.

The bonding resin contains the abrasive material in dispersed form. According to the invention, this is preferably finely classified diamond, silicon carbide (SiC), Al₂O₃, and the so-called superabrasives, such as cubic boron nitride (c-BN), TiC, ZrC, HfC, mixtures of these carbides, TiN, ZrN, HfN or mixtures of these nitrides. According to the invention, the use of finely classified diamond as abrasive material is preferred. The abrasive particles preferably have a size of 1 to 25 μm, particularly preferably 5 to 20 μm. According to the present invention, mixtures of the above substances may also be used as abrasive particles.

According to the present invention, the abrasive mixture comprises 0.1% by weight to 60% by weight, preferably 20% by weight to 40% by weight, of abrasive material, based on the total weight of the abrasive mixture.

Depending on the desired use, that weight ratio of fibers to abrasive mixture is 4:1 to 1:4. A person skilled in the art can optimize the weight ratio without problems by taking into account the required properties of the sawing yarn.

The abrasive mixture may furthermore contain conventional additives, such as parting agents, lubricants, fillers, pigments, adhesion promoters, stabilizers, inhibitors or accelerator systems. These additives are known in principle to a person skilled in the art and can be selected without problems by a person skilled in the art according to the requirement profile of the sawing yarn.

If the chosen coating process does not permit the addition of the individual components, the abrasive mixture can be prepared in a simple manner known to a person skilled in the art by mixing the individual components, for example in a ball mill.

As mentioned above, the sawing yarn according to the invention can be produced in a simple manner. The fibers are commercially available and are provided in the form of a roving of 200 to 1000, preferably 200-800, fibers. This roving is then coated or filled with the abrasive mixture.

The coating and/or filling can be carried out, for example, by means of the melt coating method. Here, the roving to be coated or to be filled is drawn through a melt comprising the bonding resin and is then cooled.

Another method for coating and/or filling the fibers is the wet impregnation method. The roving is provided on a so-called roving frame and is unwound from this at a speed of about 300-400 m/min. The unwound fibers are drawn through a liquid impregnating bath which contains the abrasive and optionally further additives in addition to the bonding resin. The solvent then has to be removed by evaporation, which is effected by drawing the coated fibers upward and downward through a “cooling tower” having different temperature zones.

In an alternative to this method, the unwound fibers are covered and filled with the abrasive mixture with the aid of a spray coating apparatus. From a rotatable apparatus arranged above the fibers, the abrasive mixture dissolved, if necessary, under pressure is sprayed onto the fibers. Present below the fibers to be sprayed is a collecting apparatus in which the abrasive mixture not applied to the fibers is collected and is fed for further use to the rotatable apparatus above the fibers. The removal of the solvent is effected analogously to the above procedure.

Alternatively, the coating and/or filling of the rovings can also be effected by means of a dry coating method. Such a method is described, for example, in EP-A-0 680 813, which is hereby incorporated by reference in this context. Here, the rovings are unwound from a roving frame analogously to the wet impregnation method. Preferably, they are first passed at a speed of about 400-600 m/min through an apparatus in which they are electrically charged. This promotes the adhesion of the abrasive mixture to the fibers. They are then passed through a sinter coating bath in which the prepared abrasive mixture is present in powder form. They are then passed through a powder coating bath in which the prepared abrasive mixture is present in powder form. Air or an inert gas is blown into the powder coating bath through holes in the bottom of the bath, with the result that a fluidized powder bath forms. The powder remains adhering to the fibers drawn through the powder coating bath. The covered fibers thus obtained are then heated. This is preferably effected by exposure to infrared light. The bonding resin present on the fibers is at least partly liquefied here, permitting an adjustment of the amount of abrasive mixture to be applied to the fibers. The rovings can be adjusted with regard to their external diameter by further heating in an oven and subsequent passage through sizing orifices.

According to a preferred variant described in WO 99/36239, which is hereby incorporated by reference in this context, the individual components of the abrasive mixture can be applied to the rovings in the dry coating method even without prior compounding. For this purpose, the individual components are introduced into the powder coating bath. There, mixing or thorough mixing is effected, for example, with the aid of a rotor, stirrer, ultrasound and/or electromagnetic waves. The mixing process must be carried out in such a way that separation of the individual components in the powder coating bath is substantially prevented or eliminated. The further processing is effected analogously to the above dry coating method.

According to the present invention, the external shape of the abrasive yarn and the distribution of the abrasive particles can be exactly adjusted by first coating the rovings only with the bonding resin or with a mixture of bonding resin and a small amount of abrasive particles in a first process step according to the dry coating method described above. The intermediate product thus obtained can then be sized to a certain dimension, since the bonding resin applied has not yet cured. In a second process step, the sized intermediate product thus obtained is drawn again through a powder coating bath which contains the abrasive particles alone or in the presence of a small amount of bonding resin. Since the bonding resin applied to the rovings has not yet cured and is therefore moist, the abrasive particles applied in the second process step can penetrate into the bonding resin. By varying the process conditions, the distribution of the abrasive particles in the abrasive mixture thus formed can be influenced. In the two-stage production method described above, however, the greater part of the abrasive particles will as a rule remain on the surface of the sawing yarn produced.

In association with the method described above, “a small amount of bonding resin or abrasive particles” means that the corresponding component is present in the corresponding powder coating bath only in an amount of not more than 5% by weight, based on the respective other component, i.e. bonding resin or abrasive particles.

According to a further embodiment of the present invention, the production of the sawing yarn is effected in the dry coating method with the aid of a twin fluid bath. Here, the rovings are fed into the first tank of the bath, where they are covered with a binder, preferably a low-viscosity binder. According to the present invention, a low-viscosity bonding resin is to be understood as meaning a resin having a viscosity of less than 500 mPa·s, preferably having a viscosity in the range of 100-500 mPa·s and particularly preferably in the range of 100 to 200 mPa·s. The yarn coated in this manner is then removed from the bath, preferably vertically, twisted and closed again. Via a deflector, the coated yarn is passed into the second tank of the twin fluid bath, where it is at least partly opened again. In the context of the present invention, partial opening is understood as meaning incomplete opening of the twist, any degree of opening between 0 and 100%, preferably between 50 and 99%, being included. The twisting and reopening of the multifilament forming the yarn can be carried out, for example, by controlling the differential speeds at deflection rolls provided. A mixture of abrasive material and some binder is present in the second tank. In the second tank, a steady state of the composition of abrasive material and bonding resin preferably forms, by means of which state a defined coating of the multifilament can be ensured. In the second tank, coating of the yarn with abrasive material and some binder takes place. The majority of the abrasive material remains on the surface of the sawing yarn. In this design of the method, however, the abrasive material is also introduced into the interior of the sawing yarn, with the result that a gradient of the abrasive material in the abrasive mixture, as described above, is formed.

In association with the method described above, “a small amount of binder” means that the corresponding component is present in the corresponding powder coating bath only in an amount of not more than 5% by weight, based on the abrasive material component.

By means of the dry coating method described above, the abovementioned bonding resins can be used without restriction for the production of the sawing yarns according to the invention. In contrast, in the production of sawing yarns by wet coating methods, only certain bonding resins can be used, depending on the fiber material used.

By means of the dry coating method described above, in particular the two-stage production method according to the invention, the dimension of the sawing yarn to be produced can be accurately established. Sawing yarns having a virtually exact cylindrical shape can be produced. In contrast, sawing yarns produced by the wet coating method suffer from bubble formation, which is caused by the required evaporation of the solvent. Sawing yarns having a smooth, virtually exact cylindrical external shape therefore cannot be obtained in this manner. The cutting properties of the sawing yarns according to the invention are therefore superior to those of the sawing yarns of the prior art.

The sawing yarn according to the invention can advantageously be used for cutting or dividing hard brittle materials. The cutting can be carried out according to a method used for this purpose. Advantageously, during this the material and the sawing yarn are cooled externally by means of a coolant, such as, for example, water.

The sawing yarn according to the invention is particularly suitable for cutting or dividing a single silicon crystal, which is usually produced by the zone melting method in the form of long ingots and has to be cut into small wafers for the semiconductor industry. Furthermore, materials such as silicon carbide (for the aerospace industry), sapphire (for watchglasses or for the production of light emitting diodes with blue light (blue LEDs), quartz, emerald, ruby, ceramic or Al₂O₃ can be cut.

By using the sawing yarn according to the invention, the cutting process can be carried out at cutting speeds substantially below 1000 m/min without this leading to disadvantages with regard to the speed of the operation. By means of the sawing yarn according to the invention, greater ablations can be achieved even at lower cutting speeds. The lower cutting speed permits higher precision of the operation and the use of materials which cannot be used in the case of conventional cutting tools, owing to the high temperatures prevailing there in the cutting process.

1. a sawing yarn comprising an abrasive mixture containing a bonding resin and abrasive material, and a multifilament of fibers which have high tensile strength and are preferably arranged substantially parallel to one another and are surrounded by the abrasive mixture, the space between the fibers being filled with the abrasive mixture, characterized in that the bonding resin contains no polytetrafluoroethylene:

2. A sawing yarn comprising an abrasive mixture containing a bonding resin and abrasive material, and a multifilament of fibers which have high tensile strength and are preferably arranged substantially parallel to one another and are surrounded by the abrasive mixture, the space between the fibers being filled with the abrasive mixture, characterized in that the amount of abrasive material in the abrasive mixture decreases gradually from the surface of the abrasive yarn to the interior.

3. The sawing yarn as claimed in claim 1, the sawing yarn having a thickness equal to or less than 350 μm.

4. The sawing yarn as claimed in claim 1, the sawing yarn having a thickness of 125-300 μm.

5. The sawing yarn as claimed in claim 1, the fibers being composed of a material from the group consisting of m- and/or p-aramid, ultra-high-strength polyethylene, highly oriented polyester, polyester, polyamide, carbon fibers, p-polyphenylene-2,6-benzobisoxazole or glass fibers, and combinations thereof.

6. The sawing yarn as claimed in claim 5, the fibers being composed of m-aramid, p-aramid or ultra-high-strength polyethylene.

7. The sawing yarn as claimed in claim 5, the fibers being composed of p-polyphenylene-2,6-benzobisoxazole.

8. The sawing yarn as claimed claim 1, the bonding resin being composed of a thermoplastic or thermosetting polymer or a combination of these materials.

9. The sawing yarn as claimed in claim 8, the bonding resin being composed of a thermosetting polymer.

10. The sawing yarn as claimed in claim 9, the thermosetting polymer being selected from the group consisting of curable phenol resins, epoxy resins, curable phenol/formaldehyde resins, MF molding materials and curable melamine/phenol/formaldehyde (MPF) molding materials, and combinations thereof.

11. The sawing yarn as claimed in claim 8, the bonding resin being composed of a thermoplastic polymer selected from the group consisting of polyimides, polyamides and polyether ether ketones.

12. The sawing yarn as claimed in claim 1, the abrasive material being selected from the group consisting of finely classified diamond, silicon carbide (SiC), Al₂O₃, cubic boron nitride (c-BN), TiC, ZrC, HfC, mixtures of these carbides, TiN, ZrN, HfN or mixtures of these nitrides, and combinations thereof.

13. The sawing yarn as claimed in claim 12, the abrasive material being finely classified diamond.

14. A method for the production of a sawing yarn as claimed in claim 1, comprising the steps
a) preparation of a multifilament of fibers having high tensile strength,
b) coating or filling of this multifilament with an abrasive mixture comprising a bonding resin and abrasive material, and
c) further processing of the multifilament thus obtained.

15. The method as claimed in claim 14, the coating or filling in step b) being effected by a wet impregnation method or a dry coating method.

16. The method as claimed in claim 15, step b) being carried out by a dry coating method by drawing the multifilament through a fluidized bed.

17. The method as claimed in claim 16, step b) being carried out in a two-stage process, first by drawing the multifilament through a fluidized bed containing bonding resin and a small amount of abrasive particles or no abrasive particles and, after subsequent sizing, again by drawing through a fluidized bed containing abrasive particles and a small amount of bonding resin or no bonding resin.

18. The method as claimed in claim 16, step b) being carried out in a twin fluid bath, comprising passing the multifilament through a first tank, containing bonding resin, and transferring the multifilament to a second tank, containing abrasive material and a small amount of bonding resin.

19. The method as claimed in claim 18, the multifilament being removed vertically from the first tank, twisted, deflected, at least partly opened and then fed into the second tank.

20. A sawing yarn produced by the method of claim 14.

21. The sawing yarn as claimed in claim 20, characterized in that the amount of abrasive particle in the abrasive material decreases from the outside to the inside.

22. The use of a sawing yarn as claimed in claim 1 for cutting hard brittle materials.

23. The use as claimed in claim 22, the hard brittle material being selected from the group consisting of single silicon crystals, silicon carbide, sapphire, quartz, emerald, ruby, ceramic and Al₂O₃.
